(19) United States
(12) Patent Application Publication
(10) Pub. No.: US 2010/0157473 A1
(43) Pub. Date: Jun. 24, 2010

(54) MAGNETIC DISK DRIVE

(75) Inventors: Yoshinobu FUCHIZAKI, Ome-shi (JP); Tomoko TAGUCHI, Kunitachi-shi (JP); Yuka AOYAGI, Irvine, CA (US)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/641,180

(22) Filed: Dec. 17, 2009

(30) Foreign Application Priority Data
Dec. 19, 2008 (JP) 2008-324329

(51) Int. Cl. G11B 5/127

(52) U.S. Cl. 360/125.02; G9B/5.041

(57) ABSTRACT

According to one embodiment, a magnetic disk drive includes a magnetic disk including a magnetic recording layer exhibiting perpendicular magnetic anisotropy, a write head including a core including a main pole and a plurality of return poles in a track direction and a direction other than the track direction with respect to the main pole, and a coil wound around corresponding to each return pole, and a read head including a magnetoresistive element and a pair of shields sandwiching the magnetoresistive element from front and rear in the track direction.

### CROSS-REFERENCE TO RELATED APPLICATIONS

This application is based upon and claims the benefit of priority from Japanese Patent Application No. 2008-324329, filed Dec. 19, 2008, the entire contents of which are incorporated herein by reference.

### BACKGROUND

1. Field

One embodiment of the present invention relates to a magnetic disk drive comprising a write head comprising a plurality of return poles.

2. Description of the Related Art

A magnetic disk drive of a perpendicular recording system comprises a write head comprising a core including a main pole and a return pole, and a coil wound around the core.

In such a magnetic disk drive, a magnetization width recorded on a medium should be reduced in order to increase recording density. For example, a write head has been proposed, in which two magnetic films are used for the main pole, the width of the magnetic film on the trailing side being broader than that of the magnetic film on the leading side in respect of the cross-track direction (see Jpn. Pat. Appln. KOKAI Publication No. 2007-220209). Also, a write head has been proposed, in which return poles are provided on the both sides of the main pole in the cross-track direction (see Jpn. Pat. Appln. KOKAI Publication No. 5-94603).

In the conventional write head, a coil is wound around the core comprising the main pole, the return pole and the contact of these poles in a plurality of turns. This is to intensify the write field emanating from the tip of the main pole, thereby to improve the signal quality recoded on the medium.

To insert a coil having many turns between the main pole and the return pole, the height of the core including the main pole and return pole should be made larger. If the height of the core is larger, it will have a long magnetic path, inevitably delaying the magnetization response in the core at high write frequency, which will distort the waveform of the output. Consequently, the output will be degraded, increasing a bit error rate, and high-density recording cannot be achieved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is a perspective view showing the write head and the magnetic disk installed in a magnetic disk drive of Example 1, and FIG. 1B is a perspective view of a core including a main pole and a return pole arranged almost in the same plane as the main pole;

FIG. 2 is a sectional view of the magnetic disk drive of Example 1 sectioned along the track direction;

FIG. 3 is a plan view showing the write head and read head of Example 1 as viewed from the air-bearing surface (ABS);

FIG. 4A is a perspective view showing the write head and the magnetic disk installed in a magnetic disk drive of Example 2, and FIG. 4B is a perspective view of a core including a main pole and a return pole arranged almost in the same plane as the main pole;

FIG. 5 is a sectional view of the magnetic disk drive of Example 2 sectioned along the track direction;

FIG. 6 is a plan view showing the write head and read head of Example 2 as viewed from the air-bearing surface (ABS);

FIG. 7A is a perspective view showing the write head and the magnetic disk installed in a magnetic disk drive of Example 3, and FIG. 7B is a perspective view of a core including a main pole and a return pole arranged almost in the same plane as the main pole;

FIG. 8 is a sectional view of the magnetic disk drive of Example 3 sectioned along the track direction;

FIG. 9 is a plan view showing the write head and read head of Example 3 as viewed from the air-bearing surface (ABS);

FIG. 10A is a perspective view showing the write head and the magnetic disk installed in a magnetic disk drive of Example 4, and FIG. 10B is a perspective view of a core including a main pole and a return pole arranged almost in the same plane as the main pole;

FIG. 11 is a sectional view of the magnetic disk drive of Example 4 sectioned along the track direction;

FIG. 12 is a plan view showing the write head and read head of Example 4 as viewed from the air-bearing surface (ABS);

FIGS. 13A to 13D are diagrams showing read outputs when the write frequency is set to 400 MHz or 600 MHz using a conventional write head;

FIG. 14 is a diagram showing a read output when the write frequency is set to 600 MHz using the write head of the present invention; and

FIG. 15 is a diagram showing frequency dependency of the read output when a conventional write head or a write head of the present invention is used.

### DETAILED DESCRIPTION

Various embodiments according to the invention will be described hereinafter with reference to the accompanying drawings. In general, according to one embodiment of the invention, there is provided a magnetic disk drive comprising: a magnetic disk comprising a magnetic recording layer exhibiting perpendicular magnetic anisotropy; a write head comprising a core comprising a main pole and a plurality of return poles in a track direction and a direction other than the track direction with respect to the main pole, and a coil wound around corresponding to each return pole; and a read head comprising a magnetoresistive element and a pair of shields sandwiching the magnetoresistive element from front and rear in the track direction.

### Example 1

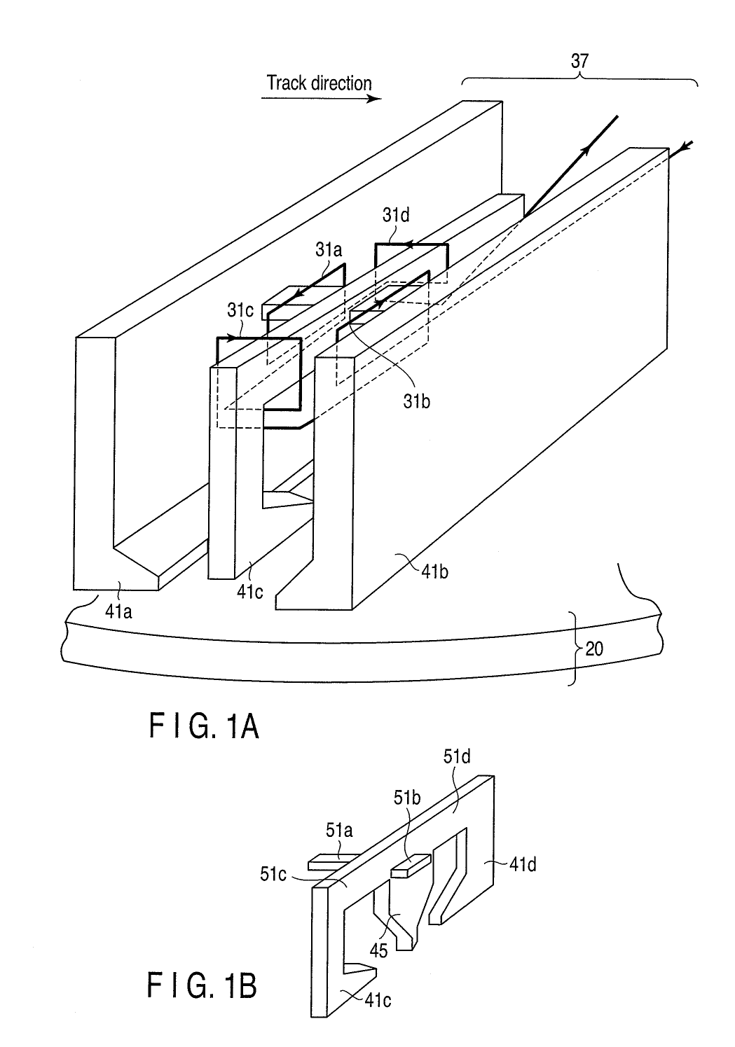

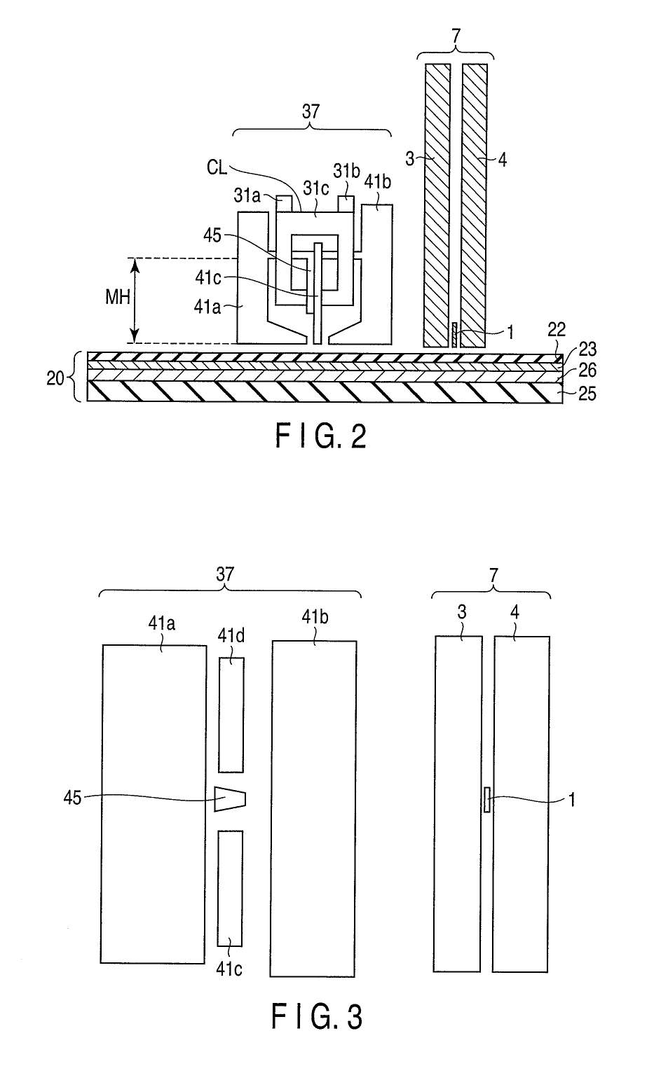

A magnetic disk drive of Example 1 will be described with reference to FIGS. 1A, 1B, 2 and 3. FIG. 1A is a perspective view showing the write head 37 and the magnetic disk 20 installed in the magnetic disk drive of Example 1. FIG. 1B is a perspective view of the core including the main pole and the return pole arranged almost in the same plane as the main pole. FIG. 2 is a sectional view of the magnetic disk drive sectioned along the track direction. FIG. 3 is a plan view showing the write head 37 and read head 7 as viewed from the air-bearing surface (ABS).

The magnetic head is of a separation type in which the write head 37 and the read head 7 are separated from each other.

The write head 37 has a core comprising the main pole 45 made of a high-permeability material and configured to generate a magnetic field perpendicular to the surface of the disk, return poles 41a, 41b, 41c and 41d, contacts 51a, 51b, 51c and 51d connecting the return poles 41a, 41b, 41c and 41d to the main pole 45, and the coil 31a, 31b, 31c, 31d wound around the core.

The return pole 41a is arranged on the rear (the trailing side) of the main pole 45 in the track direction. The return poles 41c and 41d are arranged on the left and right sides of the main pole 45 in the cross-track direction. The return pole 41b is arranged on the front (the leading side) of the main pole 45 in the track direction. Thus, four return poles are provided, two on the front and rear of the main pole 45 in the track direction and other two on the left and right sides of the main pole 45 in the cross-track direction.

Each coil 31a, 31b, 31c, 31d is wound around each contact 51a, 51b, 51c and 51d corresponding to each return pole in only one turn. In this Example, the coil 31b, 31c, 31a, 31d is connected in series as indicated by the arrows in FIG. 1A. When a current is made to flow in the coil 31a, 31b, 31c, 31d as indicated by the arrows in FIG. 1A, the main pole 45 generates a magnetic field in the same direction.

The read head 7 has the magnetoresistive film 1 and soft-magnetic shields 3 and 4 sandwiching the magnetoresistive film 1 from the front and rear in the track direction.

The magnetic disk 20 has a structure that, on the substrate 25, the soft-magnetic underlayer 26, the magnetic recording layer 23 exhibiting perpendicular magnetic anisotropy, and the protective film 22 are stacked.

As described above, each coil 31a, 31b, 31c, 31d is wound around corresponding to each return pole in only one turn. In other words, where CL is the maximum length of one turn of each coil 31a, 31b, 31c, 31d and MH is the height measured from the tip of the main pole 45 to the contact 51a or 51b, they satisfy the following relationship: CL<2π×MH.

As described above, the coil is wound around the return pole many turns in the conventional write head. The magnetic path in the core is made long, delaying the magnetization response in the core at high write frequencies and distorting the output waveform. As a result, the output is degraded, increasing the bit error rate, and high-density recording cannot be achieved. In order to shorten the magnetic path, the number of turns of the coil wound around the return pole may be reduced. In this case, however, the write field emanating from the tip of the main pole becomes weak, degrading the signal quality recorded on the magnetic disk.

If each coil 31a, 31b, 31c, 31d is wound around corresponding to each return pole in only one turn as in this Embodiment, the magnetic path of the core comprising the main pole 45 and the return poles can be shorter than in the case where a coil is wound around the return pole in many turns as in the conventional write head. In addition, since the total number of turns of the four coils is almost the same as in the conventional write head, the write field emanating from the tip of the main pole 45 will not be lowered. Thus, not only the total number of turns of the coil can remain the same as in the conventional write head, but also the magnetic path of the core comprising the main pole and return poles can be shortened. Therefore, the magnetization response of the core can be improved when the recording is performed at a high frequency, thereby eliminating output waveform distortion, and a high recording density can be achieved.

### Example 2

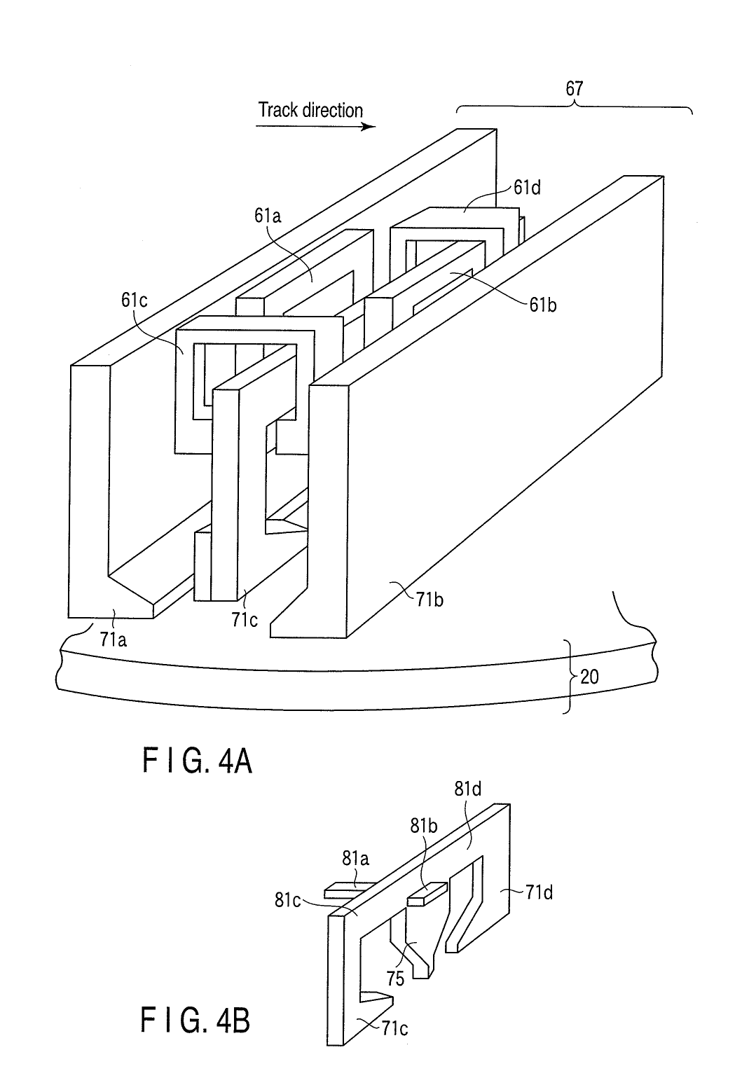

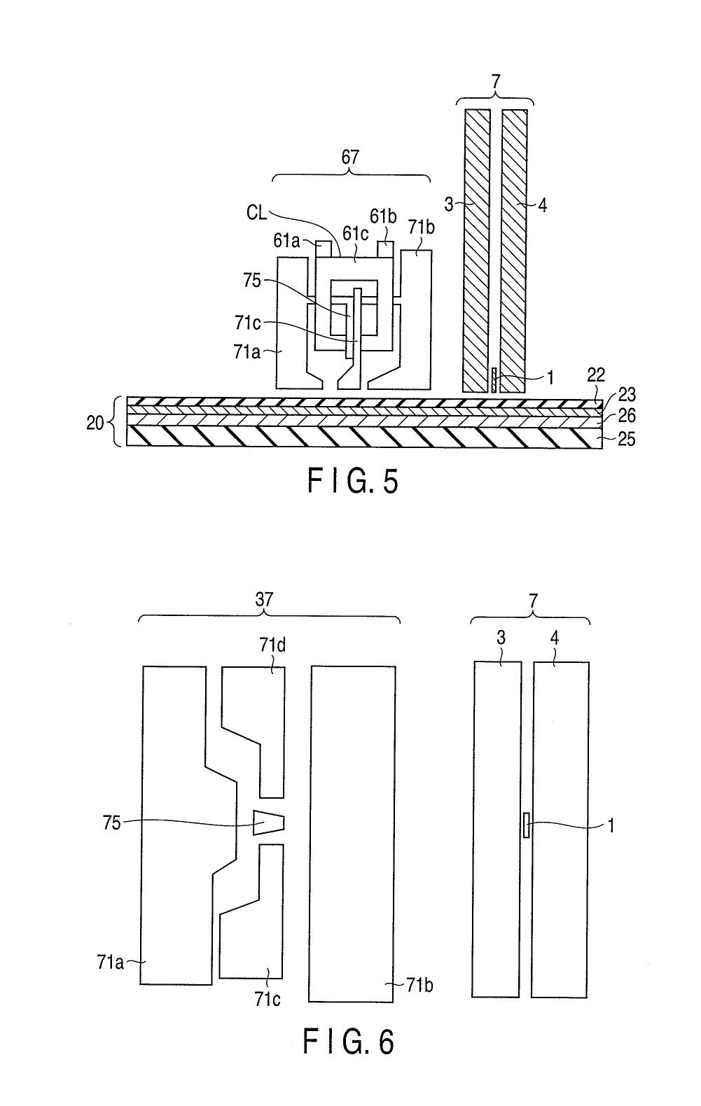

A magnetic disk drive of Example 2 will be described with reference to FIGS. 4A, 4B, 5 and 6. FIG. 4A is a perspective view showing the write head 67 and the magnetic disk 20 installed in the magnetic disk drive of Example 2. FIG. 4B is a perspective view of the core including the main pole and the return pole arranged almost in the same plane as the main pole. FIG. 5 is a sectional view of the magnetic disk drive sectioned along the track direction. FIG. 6 is a plan view showing the write head 67 and read head 7 as viewed from the air-bearing surface (ABS). Some components that are identical to those of Example 1 will be omitted from description.

The write head 67 has a core comprising the main pole 75 made of a high-permeability material and configured to generate a magnetic field perpendicular to the surface of the disk, return poles 71a, 71b, 71c and 71d, contacts 81a, 81b, 81c and 81d connecting the return poles 71a, 71b, 71c and 71d to the main pole 75, and coil 61a, 61b, 61c, 61d wound around the core.

The return pole 71a is arranged on the rear (the trailing side) of the main pole 75 in the track direction. The return poles 71c and 71d are arranged on the left and right sides of the main pole 75 in the cross-track direction. The return pole 71b is arranged on the front (the leading side) of the main pole 75 in the track direction. Thus, four return poles are provided, two on the front and rear of the main pole 75 in the track direction and the other two on the right and left sides of the main pole 75 in the cross-track direction. The lower ends of the return poles 71c and 71d on the ABS side project toward the return pole 71a and having broader widths. The return poles 71c and 71d can therefore suppress fringing.

Each coil 61a, 61b, 61c, 61d is wound around each contact 81a, 81b, 81c and 81d corresponding to each return pole in only one turn. FIG. 4A shows that each coil 61a, 61b, 61c, 61d is wound in only one turn, and the connecting manner thereof is not shown. However, the coil is connected in series in the same manner as shown in FIG. 1A.

Also in this Example, where CL is the maximum length of one turn of each coil 61a, 61b, 61c, 61d and MH is the height measured from the tip of the main pole 75 to the contact 81a or 81b, they satisfy the following relationship: CL<2π×MH. This Example can achieve the same advantages as Example 1.

### Example 3

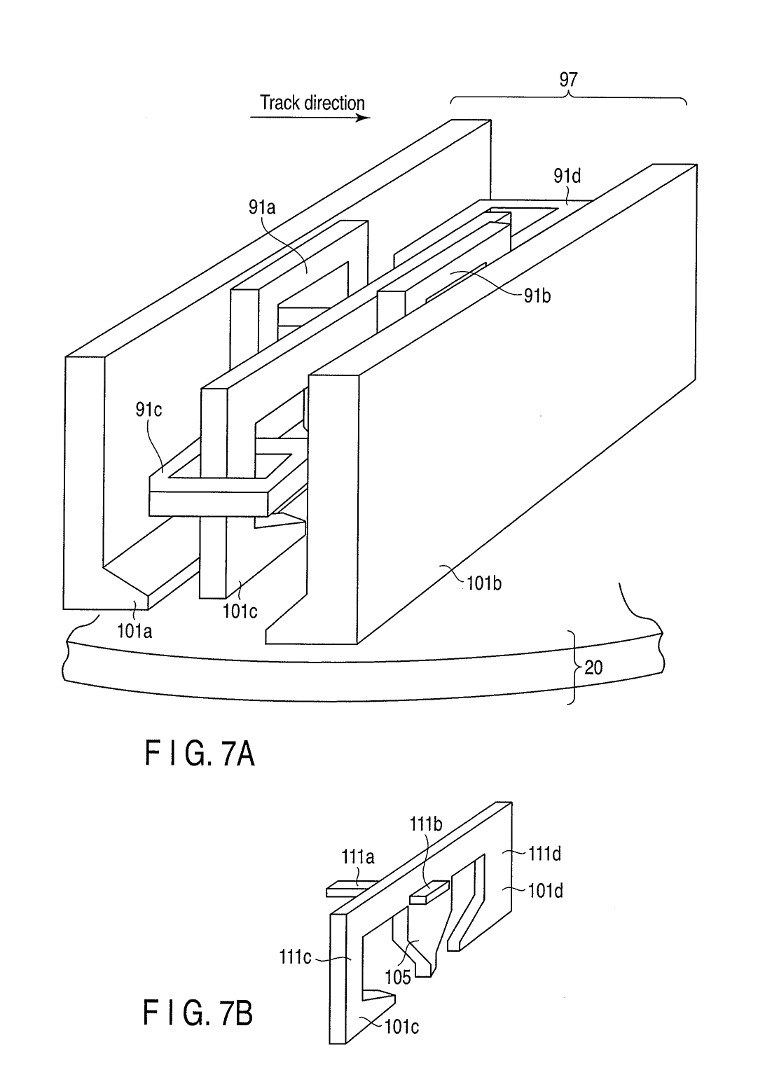

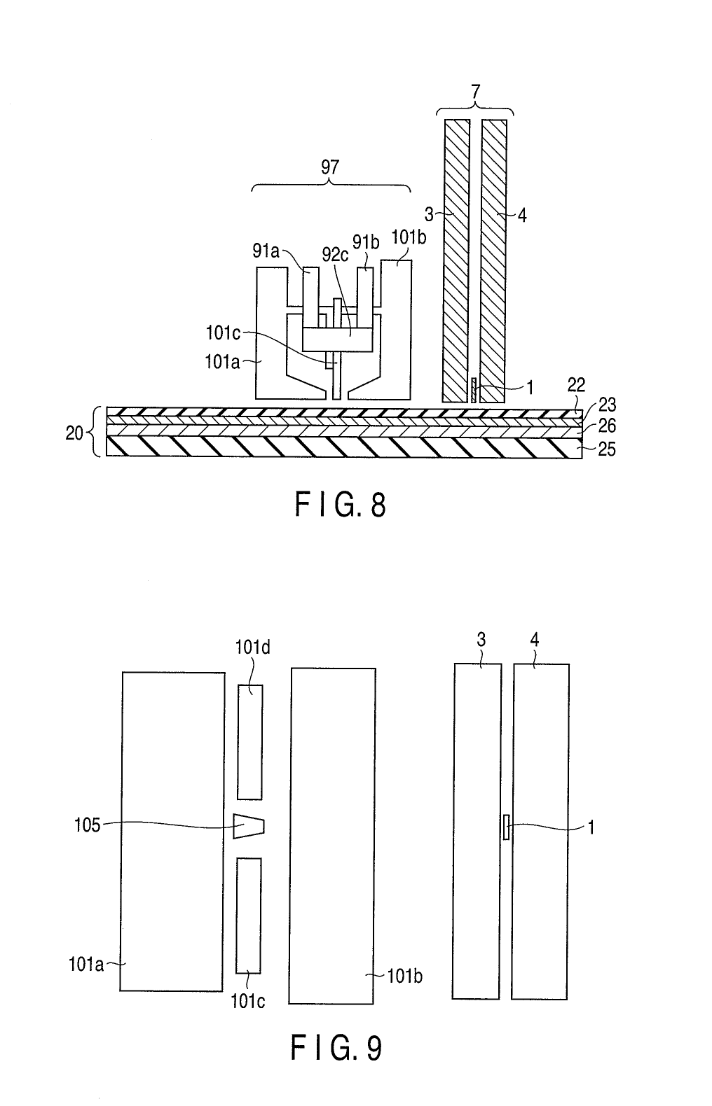

A magnetic disk drive of Example 3 will be described with reference to FIGS. 7A, 7B, 8 and 9. FIG. 7A is a perspective view showing the write head 97 and the magnetic disk 20 installed in the magnetic disk drive of Example 3. FIG. 7B is a perspective view of the core including a main pole and a return pole arranged almost in the same plane as the main pole. FIG. 8 is a sectional view of the magnetic disk drive sectioned along the track direction. FIG. 9 is a plan view showing the write head 97 and read head 7 as viewed from the air-bearing surface (ABS). Some components that are identical to those of Example 1 will be omitted from description.

The write head 97 has a core comprising the main pole 105 made of a high-permeability material and configured to generate a magnetic field perpendicular to the surface of a disk, return poles 101a, 101b, 101c and 101d, contacts 111a, 111b, 111c and 111d connecting the return poles 101a, 101b, 101c and 101d to the main pole 105, and coil 91a, 91b, 91c, 91d wound around the core.

The return pole 101a is arranged on the rear (the trailing side) of the main pole 105 in the track direction. The return poles 101c and 101d are arranged on the left and right sides of the main pole 105 in the cross-track direction. The return pole 101b is arranged on the front (the leading side) of the main pole 105 in the track direction. Thus, four return poles are provided, two on the front and rear of the main pole 105 in the track direction and the other two on the left and right sides of the main pole 105 in the cross-track direction.

Each coil 91a, 91b, 91c, 91d is wound around each contact 111a, 111b, 111c and 111d corresponding to each return pole in only one turn. FIG. 7A shows that each coil 91a, 91b, 91c, 91d is wound in only one turn, and the connecting manner thereof is not shown. However, the coil is connected in series in the same manner as shown in FIG. 1A.

Each coil 91c, 91d corresponding to each return pole 101c and 101d arranged on the left and right sides in the cross-track direction is wound horizontally, almost orthogonal to each coil 91a, 91b corresponding to each return pole 101a and 101b arranged on the front and rear of the main pole 95 in the track direction. Since a part of the coil is horizontally arranged, the magnetic path defined by the main pole 105 and the return poles 101c and 101d can be shorter than otherwise.

Also in this Example, where CL is the maximum length of one turn of each coil 91a, 91b, 91c, 91d and MH is the height measured from the tip of the main pole 105 to the contact 111a or 111b, they satisfy the following relationship: CL<2π×MH. This Example can achieve the same advantages as Example 1.

### Example 4

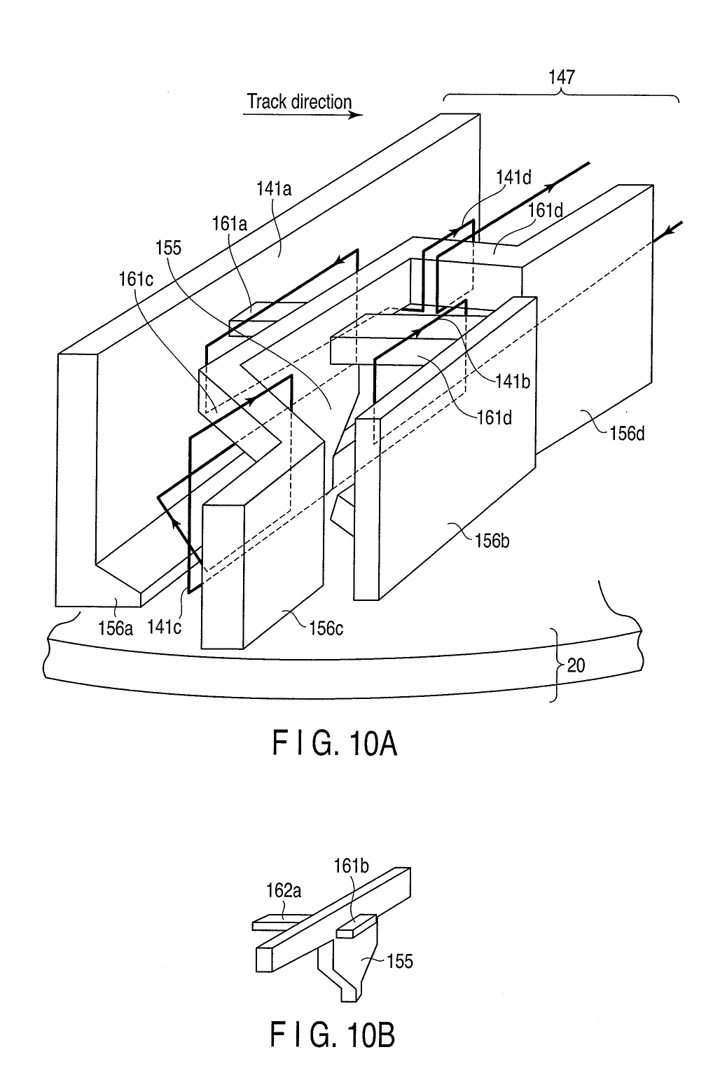

A magnetic disk drive of Example 4 will be described with reference to FIGS. 10A, 10B, 11 and 12.

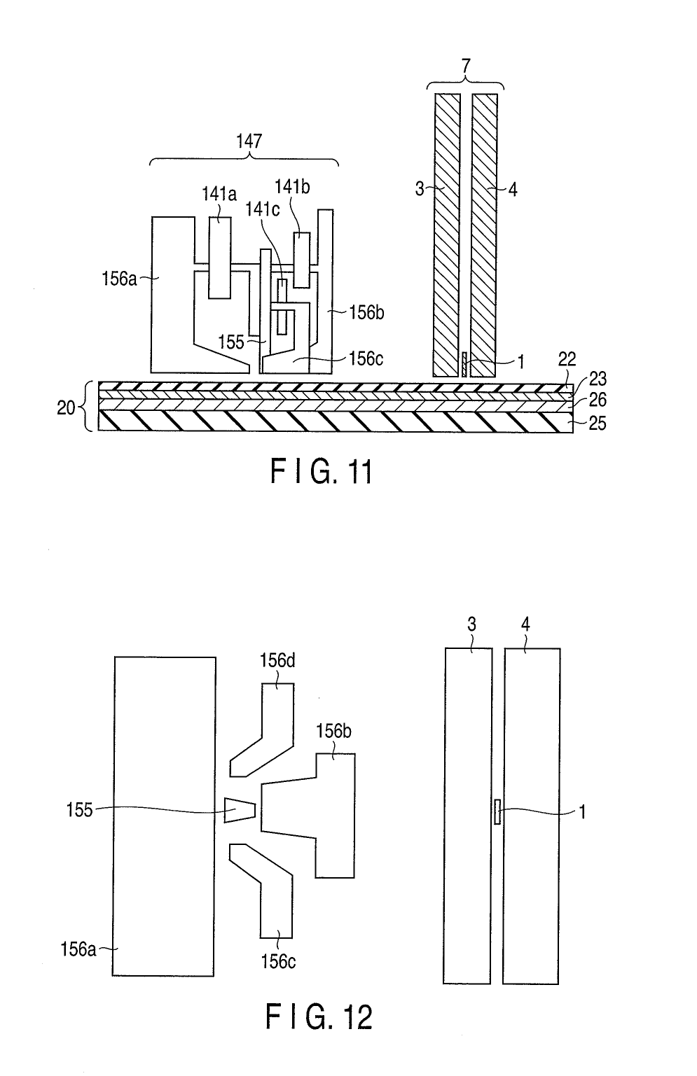

FIG. 10A is a perspective view showing the write head 147 and the magnetic disk 20 installed in the magnetic disk drive of Example 4. FIG. 10B is a perspective view of the core including a main pole and a return pole arranged almost in the same plane as the main pole. FIG. 11 is a sectional view of the magnetic disk drive sectioned along the track direction. FIG. 12 is a plan view showing the write head 97 and read head 7 as viewed from the air-bearing surface (ABS). Some components that are identical to those of Example 1 will be omitted from description.

The write head 147 has a core comprising the main pole 155 made of a high-permeability material and configured to generate a magnetic field perpendicular to the surface of a disk, return poles 156a, 156b, 156c and 156d, contacts 161a, 161b, 161c and 161d connecting the return poles 156a, 156b, 156c and 156d to the main pole 155, and coil 141a, 141b, 141c, 141d wound around the core.

The return pole 156a is arranged on the rear (the trailing side) of the main pole 155 in the track direction. The return poles 156c and 156d are arranged on the left and right sides of the main pole 155 and displaced forwards (toward the leading side) in the track direction. The return pole 156b is arranged on the front (the leading side) of the main pole 155 in the track direction. Thus, four return poles are provided, two on the front and rear of the main pole 155 in the track direction and the other two on the left and right sides of the main pole 155 in the cross-track direction.

Each coil 141a, 141b, 141c, 141d is wound around each contact 161a, 161b, 161c and 161d corresponding to each return pole in only one turn. In this Example, the coil 141a, 141b, 141c, 141d is connected in series as indicated by the arrows in FIG. 10A. When a current is made to flow in the coil 141a, 141b, 141c, 141d as indicated by the arrows in FIG. 10A, the main pole 155 generates a magnetic field in the same direction.

In this Example, since the return poles 156c and 156d are displaced forward the leading side with respect to the main pole 155, the coil 141a, 141b, 141c, 141d can have a face arranged almost parallel to one another. With this structure, the coil 141a, 141b, 141c, 141d can be easily formed in deposition processes.

Also in this Example, where CL is the maximum length of one turn of each coil 141a, 141b, 141c, 141d and MH is the height measured from the tip of the main pole 105 to the contact 161a or 161b, they satisfy the following relationship: CL<2π×MH. This Example can achieve the same advantages as Example 1.

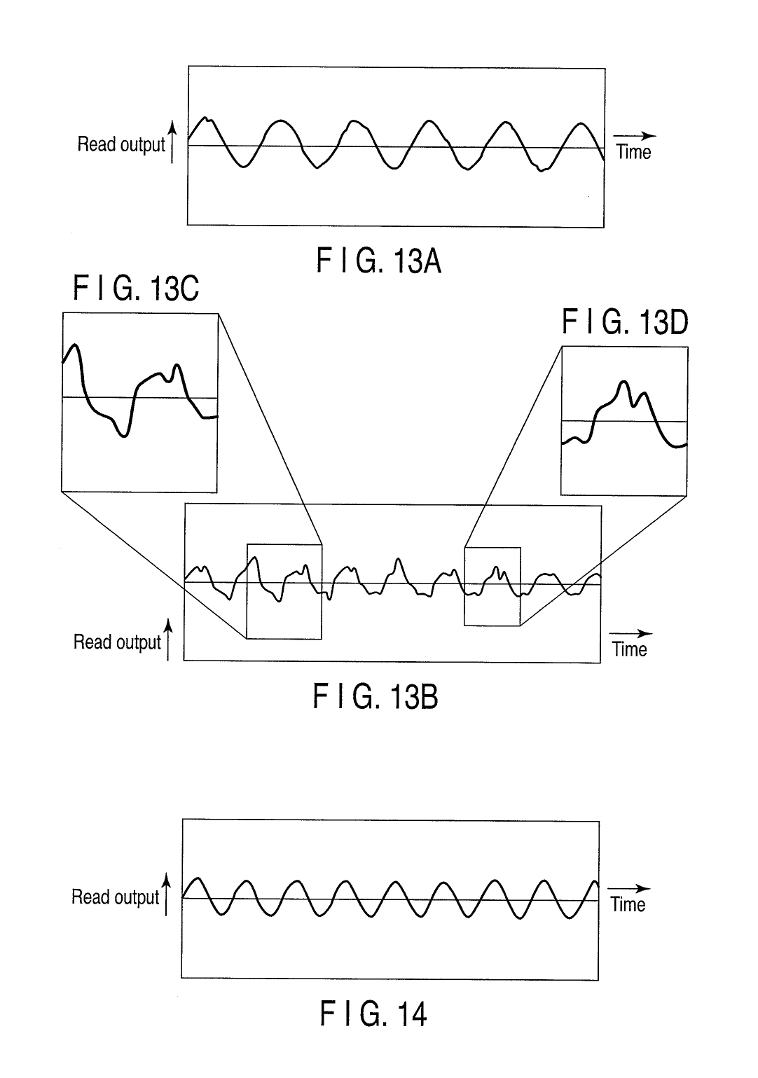

If a coil is wound around one return pole in a plurality of turns such as four turns as in the conventional write head, the physical length of the core including the main pole and the return pole, i.e., the magnetic path, is made longer in order to form the multi-turn coil between the main pole and the return pole. When the magnetic path of the core is made longer, the magnetization response of the core will be delayed, inevitably distorting the output waveform. Consequently, the average output and the output dispersion will be degraded. This disadvantage will be described with reference to FIG. 13A to 13D.

FIG. 13A is a diagram showing the waveform of a read output when recording is performed at a frequency of 400 MHz using a conventional write head. FIG. 13B is a diagram showing the waveform of a read output when recording is performed at a frequency of 600 MHz using the conventional write head. FIGS. 13C and 13D are enlarged views of parts of the waveform in FIG. 13B. In FIG. 13A, the output waveform is sinusoidal. However, in FIG. 13B and in FIGS. 13C and 13D that are enlarged views of FIG. 13B, the output waveform has double-peak, showing the output waveform is distorted. As a result, the average output and the output dispersion is also degraded.

FIG. 14 is a diagram a diagram showing the waveform of a read output when recording is performed at a frequency of 600 MHz using a write head according to the present invention. When the write head of the present invention is used, the magnetization response of the write head remains unchanged even if the write frequency becomes higher, bringing about no distortion in the output waveform. As a result, both the output degradation and output fluctuation can be suppressed.

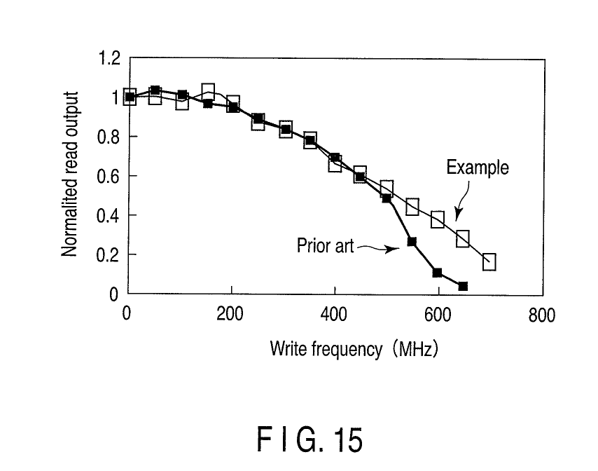

FIG. 15 is a diagram showing frequency dependency of the read output when a conventional write head or a write head of the present invention is used. When the conventional write head is used and recording is performed at a frequency of 500 MHz or more, the output is more abruptly degraded than degradation through waveform interference by adjacent bits. By contrast, when the write head of the present invention is used, even if recording is performed at a frequency of 500 MHz or more, no output degradation is observed over degradation through waveform interference by adjacent bits. Therefore, the write head according to the present invention can help to achieve high-density recording compared to the conventional one.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk drive comprising:
a magnetic disk comprising a magnetic recording layer exhibiting perpendicular magnetic anisotropy;
a write head comprising a core comprising a main pole and a plurality of return poles in a track direction and a direction other than the track direction with respect to the main pole, and coils around return poles; and
a read head comprising a magnetoresistive element and a pair of shields holding the magnetoresistive element from front and rear in a track direction.

2. The magnetic disk drive of claim 1, wherein the coils are connected in series.

3. The magnetic disk drive of claim 1, wherein each coil is wound around only one turn corresponding to each return pole.
